(19) United States
(12) Patent Application Publication
(10) Pub. No.: US 2019/0127229 A1
(43) Pub. Date: May 2, 2019

(54) TARGETED PRODUCTION OF 2,2,3,3-TETRASILYL TETRASILANE

(71) Applicant: Evonik Degussa GmbH, Essen (DE)

(72) Inventors: Harald STUEGER, Graz (AU); Michael HAAS, Oakleigh Victoria (AU); Viktor-Stavros CHRISTOPOULOS, Graz (AU); Odo WUNNICKE, Muenster (DE)

(73) Assignee: Evonik Degussa GmbH, Essen (DE)

(21) Appl. No.: 16/089,921

(22) PCT Filed: Mar. 28, 2017
(86) PCT No.: PCT/EP2017/057251

§ 371 Date: Sep. 28, 2018

(30) Foreign Application Priority Data
Apr. 1, 2016 (DE) 10 2016 205 446.5

(51) Int. Cl. C01B 33/04; C09D 1/00

(52) U.S. Cl. CPC C01B 33/04; C09D 1/00

(57) ABSTRACT

The present invention provides the octasilane 2,2,3,3-tetrasilyltetrasilane 1, compositions comprising one or more additional constituents that are not 1 as well as 2,2,3,3-tetrasilyltetrasilane 1, processes for preparing 2,2,3,3-tetrasilyltetrasilane 1 and mixtures of higher hydridosilanes that include 1. The present invention further provides for the use of 1 and mixtures of higher hydridosilanes including 1 for deposition of silicon-containing material.

The present invention provides the octasilane 2,2,3,3-tetrasilyltetrasilane 1, compositions comprising one or more additional constituents that are not 1 as well as 2,2,3,3-tetrasilyltetrasilane 1, processes for preparing 2,2,3,3-tetrasilyltetrasilane 1 and mixtures of higher hydridosilanes that include 1. The present invention further provides for the use of 1 and mixtures of higher hydridosilanes including 1 for deposition of silicon-containing material.

Silicon-containing material, for example silicon-containing layers or films on a carrier, find use as semiconductor, insulator or sacrificial layer, for example in the production of electronic circuits and in the production of photovoltaic cells for generation of electrical current from light.

Higher silicon hydrides SiₙH_{(2n°m)} with m=0, 2 and n≥3, also called silanes or hydridosilanes, formed exclusively from silicon and hydrogen, are important starting materials for deposition of Si or SiO₂ from the liquid phase for use in various applications. Higher SiₙH₍₂ₙ₊ₘ₎ with m=0, 2 and n≥6 have to date been detected only in small amounts in mixtures with other hydridosilanes which have been obtained from the hydrolytic breakdown of metal silicides or from the breakdown of SiH₄ or Si₂H₆ with expenditure of energy and subsequent oligomerization.

However, it is not possible to isolate individual species such as 1 because of intrinsic physical properties of hydridosilanes, for example similar boiling points or chemical lability. For instance, WO 2015/034855 A1 discloses the nonasilane 2,2,4,4-tetrasilylpentasilane 4, prepared by the thermal conversion of neopentasilane 3, also referred to as Si(SiH₃)₄ or 2,2-disilyltrisilane. Also disclosed is the use of 4 in the form of the crude product for further production of silicon-based materials. However, pure 4 and the analytical data of pure 4 are not disclosed.

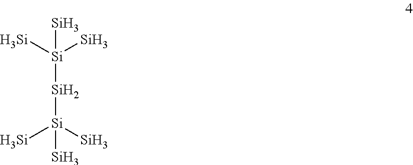

Gmelin Handbook of Inorganic Chemistry, 15(B1), Springer Verlag (1982), 204-206 postulates, among the constitutionally isomeric octasilanes, a 2,2,3,3-tetrasilyltetrasilane 1 on the basis of ¹H NMR and Raman data.

Lobreyer, Sundermeyer and Oberhammer disclose, in Chem. Ber. 1994, 127, 2111-2115, the conversion of monosilane SiH₄ in dispersions of sodium and potassium, and alkali metal silanides (M)SiH₃₋ₙ(SiH₃)ₙ with n=0-3 and M=potassium or sodium are obtainable in an aggregation or oligomerization reaction. By protonation or silylation with suitable reagents, the corresponding silanes, for example disilane H₃SiSiH₃, trisilane H₂Si(SiH₃)₂, isotetrasilane HSi(SiH₃)₃ and neopentasilane Si(SiH₃)₄, abbreviated to 3 in the context of this application, are obtainable, but only in a mixture.

Amberger and Mahlhofer disclose, in J. Organometal. Chem. 12 (1968), 55-62, the reaction of potassium monosilanide KSiH₃ with halogen compounds of the 4th main group of the Periodic Table of the Elements and obtain, in a salt elimination or metathesis reaction with methyl iodide or trimethylchlorosilane, the following coupling products:

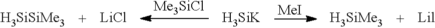

Haase and Klingenbiel disclose, in Z. anorg. allg. Chem. 524 (1985), 106-110, the analogous salt elimination or metathesis reaction of lithium tris(trimethylsilyl)silane with halosilanes, for example SiCl₄, to give:

(Me₃Si)₃SiLi+SiCl₄→(Me₃Si)₃SiSiCl₃+LiCl

Tyler, Sommer and Whitmore already disclose, in J. Am. Chem. Soc. 1948, 70, 2876-2878, the reaction of t-butyllithium with SiCl₄ in a salt elimination or metathesis reaction according to:

Me₃CLi+SiCl₄→Me₃CSiCl₃+LiCl

Stüger et al. disclose, in Chem. Eur. J. 2012, 18, 7662-7664, the reaction of alkali metal silanides of the isotetrasilane (M)Si(SiH₃)₃ with M=lithium, sodium, potassium, with organochlorosilanes in a further form of the salt elimination or metathesis reaction according to:

(Me₃Si)₃SiLi+PhR₂SiCl→(Me₃Si)₃SiSiR₂Ph+LiCl (R=Me, H)

It is known that higher silanes, for example hydridosilanes having at least eight silicon atoms, are no longer self-igniting on contact with air. They therefore have safety-relevant advantages compared to lower silanes, for example mono-, di- or trisilane, in an industrial application.

With regard to formation of silicon-containing material, for example silicon-containing layers or films on a carrier, as detailed at the outset, desirable hydridosilanes are those which have a breakdown temperature below their respective boiling points. This minimizes evaporation losses during the thermal breakdown. In addition, desirable hydridosilanes have a boiling point around 25° C. under standard pressure, in order to enable purification of the hydridosilane with minimum breakdown, for example by a distillative workup. 2,2,3,3-Tetrasilyltetrasilane 1 should exhibit these two properties in a virtually ideal manner. It is one object of the present invention to prepare the octasilane 2,2,3,3-tetrasilyltetrasilane 1 selectively in pure form and in preparatively usable amounts.

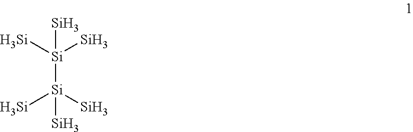

This object is achieved by the hydridosilane of the formula 1, characterized by the molecular mass, determined by mass spectrometry, of 242 g/mol, by a ²⁹Si NMR spectrum with 2 resonance signals, the first signal having a chemical shift of δ=−92.71 ppm and the form of a quartet with a heteronuclear coupling ¹J_{Si—H}=201 Hz (SiH₃), and the second signal a chemical shift of δ=−150.42 ppm and the form of a multiplet with a heteronuclear coupling ²J_{Si—H}=3 Hz, (Si_{q}); by a ¹H NMR spectrum with signals typical of SiH₃— groups and a chemical shift in the region of 3 to 4 ppm, where the integration across these signals corresponds to a sum total of 18 protons and the chemical shifts of the ²⁹Si and ¹H NMR spectra are based on tetramethylsilane as reference standard, as disclosed in the Experimental of this application.

One aspect of the subject-matter of the invention is the hydridosilane of the formula 2, characterized by the molecular mass, determined by mass spectrometry, of 332 g/mol, by a ²⁹Si NMR spectrum with 4 resonance signals, the first signal having a chemical shift of δ=−146.50 ppm and the form of a multiplet with a heteronuclear coupling of ²J_{Si—H}=2.7 Hz (Si(SiH₃)₃), the second signal a chemical shift of δ=−135.26 ppm and the form of a multiplet with a heteronuclear coupling of ²J_{Si—H}=3.0 Hz (Si(SiH₃)₂), the third signal a chemical shift of δ=−93.65 ppm and the form of a quartet with heteronuclear coupling constants of¹J_{Si—H}=201.4 Hz and ³J_{Si—H}=3.2 Hz (Si(SiH₃)₂), and the fourth signal a chemical shift of δ=−90.11 ppm and the form of a quartet with heteronuclear coupling constants of ¹J_{Si—H}=201.6 Hz, and ³J_{Si—H}=3.6 Hz (Si(SiH₃)₃); by a ¹H NMR spectrum with signals typical of SiH₃— groups and a chemical shift in the region of 3 to 4 ppm, where the chemical shift of the ¹H NMR spectrum is based on tetramethylsilane as reference standard, as disclosed in the Experimental of this application.

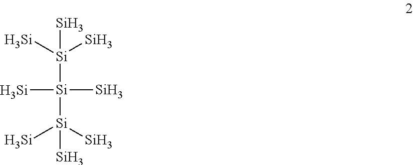

The invention further provides a composition comprising 2,2,3,3-tetrasilyltetrasilane of the formula 1 and one or more additional constituents that are not 2,2,3,3-tetrasilyltetrasilane 1. Additional constituents in the context of the invention are understood to mean, as well as chemical compounds, also mixtures that have not been characterized in detail, for example breakdown products.

One aspect of the subject-matter of the invention is a composition comprising 1 and one or more additional constituents that are not 1, comprising at least 30 area % of 1, not more than 10 area %, preferred from 0.01 to 10, particularly preferred from 0.1 to 9 area % of 2 and not more than 30 area % of 3, preferred 0.01 to 30, particularly preferred 0.1 to 25 area % of 3, where the difference from 100 area % includes higher hydridosilanes of the formula SiₙH₂₊ₘ with m=0 or 2 and n≥5, preferably with m=2, unconverted reactants and by-products of the reaction that are not hydridosilanes, and where the stated area percentages are based on the total area of a gas chromatography measurement. By-products of the reaction are understood in the context of the invention to mean, for example, the lithium halides formed.

Preferred inventive compositions are comprising tetrasilsilyltetrasilane of the formula 1 and hydridosilane of the formula 2, preferably in a ratio of the area % of the respective species ranging from 2 to 1 till 20 to 1, particularly preferred ranging from 3 to 1 till 10 to 1. Particularly preferred compositions are comprising tetrasilsilyltetrasilane of the formula 1, hydridosilane of the formula 2 and neopentasilane of the formula 3, preferably in a ratio of the area % of the sum of the compounds of formulae 1 and 2 to the area % of compound of the formula 3 from 2 to 1 till 20 to 1, preferred from 4 to 1 till 10 to 1. Even more preferred compositions are comprising tetrasilsilyltetrasilane of the formula 1, hydridosilane of the formula 2, neopentasilane of the formula 3 and compounds of formula SiₙH₂ₙ₊ₘ with m=0 or 2 and n>11, preferably with m=2, preferably in a ratio of the area % of the sum of the compounds of formulae 1 to 3 to the area % of compounds of formula SiₙH₂ₙ₊ₘ with m=0 or 2 and n>11, preferably with m=2, from 1 to 1 till 20 to 1, preferred 3 to 1 till 6 to 1. The stated area percentages are based on the total area of a gas chromatography measurement, conducted as given below.

The invention further provides a composition, freed of unconverted reactants and by-products of the reaction, which is in the liquid phase under standard conditions/SATP, comprising 50-70 area % of 1, 2 and higher hydridosilanes of the formula SiₙH₂ₙ₊ₘ with m=0 or 2 and n>5, preferably with m=2, where the difference from 100 area % comprises nonvolatile higher hydridosilanes and where the stated area percentages are based on the total area of a gas chromatography measurement. Nonvolatile higher hydridosilanes in the context of the invention are understood to mean hydridosilanes of the formula SiₙH₂ₙ₊ₘ with m=0, 2 and n>11, preferably with m=2.

One aspect of the subject-matter of the invention is a process for preparing higher hydridosilanes of the formula SiₙH₂ₙ₊ₘ with m=0 or 2 and n≥5, preferably with m=2, characterized by the following sequence of steps:
a) providing metal silanides of the formula M(SiₙH₂ₙ₊ₘ)ₒ with 1≤n≤12, m=1, −1, o=1, 2 and M=alkali metal, alkaline earth metal, preferably m=1, M=Li;
b) reacting metal silanides of the formula M(SiₙH₂ₙ₊ₘ)ₒ with 1≤n≤12, m=1, −1, o=1, 2 and M=alkali metal, alkaline earth metal, preferably with m=1, M=Li, with electrophiles selected from the group of the element halides and the element organyl halides, where the subgroup of the element organyl halides comprises element alkyl or aryl halides, each of the 4th main group of the Periodic Table of the Elements, preferably selected from halosilanes of the formula Si_{y}X_{2y+2} with 1≤y≤3 and/or alkyl halides of the formula CₚH_{q}Xᵣ with p=1 to 6, where q can assume the values of 0 to 2p+1, and where r can assume the values of 1 to 2p+2, more preferably with halogen X=chlorine, bromine, especially SiCl₄ and/or dibromoethane;
c) working up the reaction mixture obtained from step b) to obtain a mixture of hydridosilanes of the formula SiₘH₂ₘ₊₂ with m≥5.

Element aryl halides of the 4th main group of the Periodic Table of the Elements are understood in the context of the present invention to mean, for example, C₆H₅SiCl₃, C₆H₅GeCl₃ or (C₆H₅)₂GeCl₂.

Advantageously, in step b) of the process according to the invention, isotetrasilanyllithium, prepared from neopentasilane 3 and methyllithium, as alkali metal silanide is reacted with dibromoethane according to route A, or SiCl₄ according to route B, to give 1 and further hydridosilanes such as undecasilane 2, with partial reformation of neopentasilane 3 according to the following reaction scheme (I):

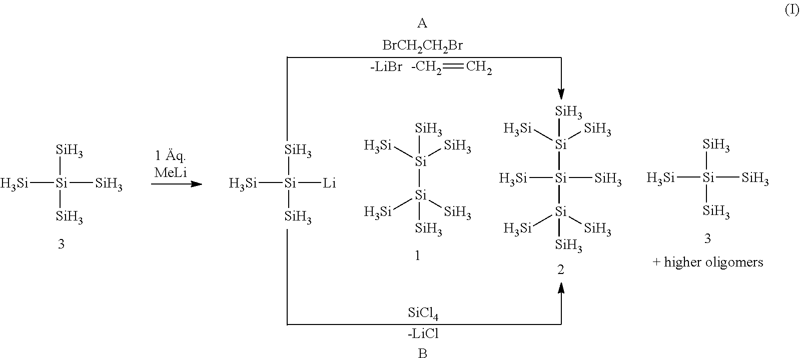

On the basis of the prior art, in the reaction of (H₃Si)₃SiLi and SiCl₄, the formation of the salt elimination product Cl₃SiSi(SiH₃)₃ was to be expected, as shown in the reaction scheme below. The formation of the octasilane (H₃Si)₃SiSi(SiH₃)₃ 1 by this route rather than the salt elimination product Cl₃SiSi(SiH₃)₃ is thus highly unexpected and surprising.

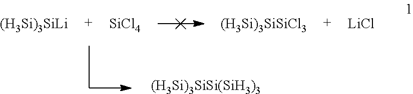

It is advantageous, in step b) of the process according to the invention, to conduct the reaction in a temperature gradient with constant homogenization of the reaction mixture, with a selected temperature range between −80° C. and 50° C., especially between 0° C. and 25° C.

It is also advantageous, in step b) of the process according to the invention, to conduct the reaction in a solvent or solvent mixture. Suitable solvents or solvent mixtures include ethers, for example diethyl ether. If the electrophile used is liquid within the temperature gradient, it can function as part of the solvent mixture or as the solvent.

In the process according to the invention, at least 0.03 equivalent of electrophile is added, based on the molar amount of the hydridosilane used, which is converted to the metal silanide. Advantageously, 0.55 equivalent, an equimolar amount or up to a ten-fold excess of electrophile is added, based on the molar amount of the hydridosilane used, which is converted to the metal silanide. In the case of use of alkali metal silanides, it is possible to establish a molar ratio of 1:10 to 1:100 000, based on the electrophile used in each case. In the latter case, the electrophile serves as part of the solvent or is the solvent, as described above.

The metal silanide is advantageously generated in situ beforehand from a hydridosilane and a metal organyl compound in a solvent or solvent mixture, the reaction being effected within a temperature range from −30° C. to +30° C., advantageously at room temperature. In the process according to the invention, equimolar amounts of metal organyl compound are added, based on the molar amount of the hydridosilane used, which is converted in situ to the metal silanide, the expression “equimolar amounts of metal organyl compound” also being understood in the context of this invention to mean molar amounts with 0.95 or 1.05 equivalents. Advantageously, at least 0.01 to 0.05 equivalent of metal organyl compound is added, based on the molar amount of the hydridosilane used, which is converted in situ to the metal silanide.

Suitable metal organyls are alkyllithium compounds, for example methyllithium; suitable solvents or solvent mixtures include ethers, for example diethyl ether. In the process according to the invention, the reaction is effected with very substantial exclusion of moisture and oxygen. This is achieved by the use of dried solvents or dried solvent mixtures having a residual water content of not more than 30 ppm by mass, and the use of an inert gas atmosphere. Inert gases are understood in the context of the invention to mean gases or gas mixtures that do not react with the starting materials and/or products in such a way that the yield of 1 or of a reactive precursor of 1 or further higher hydridosilanes is reduced. Suitable inert gases or inert gas mixtures are very substantially free of oxygen and include dried nitrogen, argon or mixtures thereof.

The workup of the reaction mixture in step c) of the process according to the invention is effected with utilization of suitable physicochemical properties of the hydridosilanes formed. These include, for example, their good solubility in nonpolar solvents or nonpolar solvent mixtures and their partial pressures. Suitable nonpolar solvents or nonpolar solvent mixtures include, for example, alkanes, especially alkanes that are in the liquid phase at 20 to 25° C. and standard pressure of 1.013 bar=1013 hPa. Suitable nonpolar solvent mixtures comprise, for example, pentane.

Advantageously, there is first an extractive separation of the hydridosilanes formed from the reaction mixture, which is followed by a distillative workup, especially a yield-conserving workup by means of a distillation or sublimation under reduced pressure.

One aspect of the subject-matter of the invention is 2,2,3,3-tetrasilyltetrasilane 1 obtainable by the following sequence of steps:
a) providing a metal silanide of the formula M(SiₙH₂ₙ₊ₘ)ₒ with 1≤n≤12, m=1, −1, o=1, 2 and M=alkali metal, alkaline earth metal, preferably with M=Li, n=4, m=1, M=Li;
b) reacting the metal silanide with an electrophile selected from the group of the element halides and the element organyl halides, where the subgroup of the element organyl halides comprises element alkyl or aryl halides, each of the 4th main group of the Periodic Table of the Elements, preferably selected from halosilanes of the formula Si_{y}X_{2y+2} with 1≤y≤3 and/or alkyl halides of the formula CₚH_{q}Xᵣ with p=1 to 6, where q can assume the values of 0 to 2p+1, and where r can assume the values of 1 to 2p+2, more preferably with halogen X=chlorine, bromine, especially SiCl₄ and/or dibromoethane;
c) working up the reaction mixture obtained from step b) to obtain a silane having mass spectrometry, ²⁹Si NMR spectroscopy and ¹H NMR spectroscopy features as disclosed in the Experimental of this application.

Step b) is advantageously effected in a temperature gradient with constant homogenization of the reaction mixture, with a selected temperature range between −80° C. and 50° C., especially between 0° C. and 25° C.

Step b) is advantageously effected using an equimolar amount up to a ten-fold excess of electrophile, or alternatively using a molar ratio of alkali metal silanide to electrophile of 1:10 to 1:100 000. If the electrophile chosen is liquid within the temperature gradient, in the latter case, it can function as the solvent or part of the solvent mixture.

Step c) is effected with utilization of suitable physicochemical properties of the hydridosilanes 1 and 2 formed, for example their good solubility in nonpolar solvents or nonpolar solvent mixtures or their partial pressures, advantageously with extractive separation of 1 and 2 from the reaction mixture. Suitable nonpolar solvents or nonpolar solvent mixtures include, for example, alkanes, especially alkanes that are in the liquid phase at 20 to 25° C. and standard pressure of 1.013 bar=1013 hPa. Suitable nonpolar solvent mixtures comprise, for example, pentane. To obtain pure 1, it is advantageous to follow the extraction with a distillative workup, in which case the distillative workup is effected under reduced pressure, for example under a reduced pressure down to 0.05 mbar=5 Pa and temperatures≤50° C., especially temperatures≤40° C. To obtain pure 2, it is advantageous that the distillation is followed by a sublimation under reduced pressure, for example under a reduced pressure down to 1×10⁻³ mbar=0.1 Pa and temperatures≤100° C., especially temperatures≤70° C.

The invention further provides higher hydridosilanes of the formula SiₙH₂ₙ₊ₘ with m=0, 2 and n≥5, preferably with m=2, obtainable by the following sequence of steps:
a) providing a metal silanide of the formula M(SiₙH₂ₙ₊ₘ)ₒ with 1≤n≤12, m=1, −1, o=1, 2 and M=alkali metal, alkaline earth metal, preferably with M=Li, n=4, m=1, M=Li;
b) reacting the metal silanide with an electrophile selected from the group of the element halides and the element organyl halides, where the subgroup of the element organyl halides comprises element alkyl or aryl halides, each of the 4th main group of the Periodic Table of the Elements, preferably selected from halosilanes of the formula Si_{y}X_{2y+2} with 1≤y≤3 and/or alkyl halides of the formula CₚH_{q}Xᵣ with p=1 to 6, where q can assume the values of 0 to 2p+1, and where r can assume the values of 1 to 2p+2, more preferably with halogen X=chlorine, bromine, especially SiCl₄ and/or dibromoethane;
c) working up the reaction mixture obtained from step b) to obtain a mixture of hydridosilanes of the formula SiₘH₂ₘ₊₂ with m≥5.

Step b) is advantageously effected in a temperature gradient with constant homogenization of the reaction mixture, with a selected temperature range between −80° C. and 50° C., especially between 0° C. and 25° C.

Step b) is advantageously effected using an equimolar amount up to a ten-fold excess of electrophile, or alternatively using a molar ratio of alkali metal silanide to electrophile of 1:10 to 1:100 000. If the electrophile chosen is liquid within the temperature gradient, in the latter case, it can function as the solvent or part of the solvent mixture.

Step c) is effected with utilization of suitable physicochemical properties of the silanes 1 and 2 formed, for example their good solubility in nonpolar solvents or nonpolar solvent mixtures or their vapour pressure, advantageously with extractive separation of 9 and 2 from the reaction mixture. Suitable nonpolar solvents or nonpolar solvent mixtures include, for example, alkanes, especially alkanes that are in the liquid phase at 20 to 25° C. and standard pressure of 1.013 bar=1013 hPa. Suitable nonpolar solvent mixtures comprise, for example, pentane.

One aspect of the subject-matter of the invention is the use of higher hydridosilanes of the formula SiₙH₂ₙ₊ₘ with m=0, 2 and n≥5, preferably with m=2, prepared in a process characterized by the reaction of metal silanides of the formula M(SiₙH₂ₙ₊ₘ)ₒ with 1≤n≤12, m=1, −1, o=1, 2 and M=alkali metal, alkaline earth metal, preferably with M=Li, n=4, m=1, M=Li, with electrophiles selected from the group of the element halides and the element organyl halides, where the subgroup of the element organyl halides comprises element alkyl or aryl halides, each of the 4th main group of the Periodic Table of the Elements, preferably selected from halosilanes of the formula Si_{y}X_{2y+2} with 1≤y≤3 and/or alkyl halides of the formula CₚH_{q}Xᵣ with p=1 to 6, where q can assume the values of 0 to 2p+1, and where r can assume the values of 1 to 2p+2, more preferably with halogen X=chlorine, bromine, especially SiCl₄ and/or dibromoethane, preferably comprising 2,2,3,3-tetrasilylsilane 1 in a composition freed of unconverted reactants and by-products of the reaction, which is in the liquid phase under standard conditions/SATP, comprising 50-70 area % of 1, 2 and higher hydridosilanes of the formula SiₙH₂ₙ₊ₘ with m=0, 2 and n>5, preferably with m=2, where the difference from 100 area % comprises nonvolatile higher hydridosilanes and where the stated area percentages are based on the total area of a gas chromatography measurement, as disclosed in the Experimental in this application, for deposition of silicon-containing layers on substrates.

The examples which follow and data disclosed in the Experimental serve to elucidate the invention, and do not constitute a mere restriction to these examples and disclosed data.

Experimental

All studies were conducted in a glovebox produced by M. Braun Inertgas-Systeme GmbH or by means of standard Schlenk methodology (D. F. Shriver, M. A. Drezdzon, The manipulation of air sensitive compounds, 1986, Wiley VCH, New York, USA) under an inert atmosphere of dry nitrogen (N₂, 5.0 purity; O₂ content: <0.1 ppm; H₂O content: <10 ppm). Dry oxygen-free solvents (diethyl ether, pentane) were prepared by means of a solvent drying system of the MB-SPS-800-Auto type, manufactured by M. Braun Inertgas-Systeme GmbH. Deuterated benzene (C₆D₆) was sourced from Sigma-Aldrich Corp. and was stored over molecular sieve (4 Å) for at least 2 days prior to use for drying purposes. Methyllithium (1.6 molar solution in diethyl ether) was purchased from Sigma-Aldrich Corp. and was used without further purification. Silicon tetrachloride and 1,2-dibromoethane were likewise purchased from Sigma-Aldrich Corp. and were degassed prior to utilization. Compound 3 was prepared by known literature methods (Stueger, H.; Mitterfellner, T.; Fischer, R.; Walkner, C.; Patz, M.; Wieber, S. Chem. Eur. J. 2012, 18, 7662-7664).

UV-Vis spectra were measured on a spectrometer of the Lambda 5 type from the company Perkin Elmer. Stem solutions of the compounds of formulae 1 and 2 are prepared in a glovebox, as described above, in a concentration of 1*10⁻² mol/L and were further diluted. The solvent was n-hexane.

NMR spectra were measured in C₆D₆ solvent on a spectrometer of the Varian NOVA 300 (1H: 300.0 MHz, ²⁹Si: 59.6 MHz) type from Varian, Inc., at room temperature. Chemical shifts are reported in comparison to an external reference (¹H and ²⁹Si: TMS, corresponding to tetramethylsilane, for δ=0 ppm). NMR spectra were evaluated with the aid of the MestReNova software from MestreLab Research, Chemistry Software Solutions. Product mixtures were examined by means of a combination of gas chromatography-mass spectrometry consisting of an HP 5890 Series II gas chromatograph coupled to an HP 5971/A mass spectrometer, both produced by Agilent Technologies, Inc. The gas chromatography separation was effected by means of an HP-1 capillary column having a length of 25 m and a diameter of 0.2 mm, 100% filled with poly(dimethylsiloxane). The ionization in the mass spectrometer was conducted by means of electron impact ionization at 70 eV. Identification of individual components in the ion chromatogram was effected via the GC retention times by comparison with the reference compounds Si₅H₁₀, corresponding to cyclopentasilane, Si₆H₁₂, corresponding to cyclohexasilane, and the characteristic fragmentation patterns in the electron impact ionization mass spectrum. The hydridosilanes were quantified by integration of the individual fractions, reported in area % and based on the total area of the ion chromatogram, the integration of the GC-MS signals having been calibrated beforehand by comparison with the integrals of resonances in ¹H NMR spectra of comparable hydridosilane mixtures, such as Si₅H₁₀, corresponding to cyclopentasilane, and Si₆H₁₂, corresponding to cyclohexasilane. The GC-MS data were evaluated with the GC-MSD ChemStation software from Agilent Technologies, Inc.

Abbreviations Used:

SATP=standard ambient temperature and pressure; 25° C.=298.15 K; 1.013 bar=1013 hPa

NPS=neopentasilane=2,2-disilyltrisilane=Si(SiH₃)₄=3

TMS=tetramethylsilane

MeLi=methyllithium

NMR=nuclear magnetic resonance

IR=infrared

MS=mass spectrometry

GC=gas chromatography

UV=ultraviolet

Vis=visible

### EXAMPLE 1

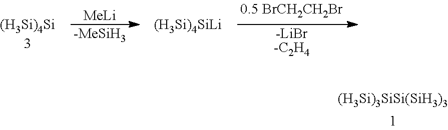

To a solution of 1.00 g NPS (6.6 mmol, 1 equivalent) in 6 ml of diethyl ether are gradually added, at −30° C., 3.95 ml of a 1.6 M solution of MeLi in diethyl ether (6.2 mmol, 0.95 eq.), and then the mixture was stirred at room temperature for 1 h. The solution of isotetrasilanyllithium thus obtained is added dropwise at 0° C. to a solution of 0.28 ml of dibromoethane (3.3 mmol, 0.55 eq.) in 12 ml of diethyl ether, and the mixture is stirred at room temperature for 45 minutes. Then the solvent is removed at 0° C. under reduced pressure, and the remaining residue is extracted 3 times with 15 ml each time of pentane and filtered off via a filter cannula. The pentane is removed by distillation from the soluble fraction at 0° C. under reduced pressure, and the remaining oily product mixture is recondensed at 38-40° C. at 0.05 mbar=5 Pa. This gives 0.21 g (28%) of pure 1 in the form of a clear oxidation-sensitive liquid.

### EXAMPLE 2

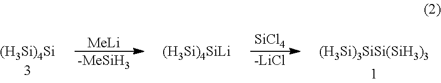

To a solution of 1.00 g NPS (6.6 mmol, 1 equivalent) in 6 ml of diethyl ether are gradually added, at −30° C., 3.95 ml of a 1.6 M solution of MeLi in diethyl ether (6.2 mmol, 0.95 eq.), and then the mixture was stirred at room temperature for 1 h. The solution of isotetrasilanyllithium thus obtained is added dropwise at 0° C. to a solution of 0.61 g of tetrachlorosilane (3.6 mmol, 0.55 eq.) in 12 ml of diethyl ether, and the mixture is stirred at room temperature for 45 minutes. Then the solvent is removed at 0° C. under reduced pressure, and the remaining residue is extracted 3 times with 15 ml each time of pentane and filtered off via a filter cannula. The pentane is removed by distillation from the soluble fraction at 0° C. under reduced pressure, and the remaining oily product mixture is recondensed at 38-40° C. at 0.05 mbar=5 Pa. This gives 0.21 g (28%) of pure 1 in the form of a clear oxidation-sensitive liquid. The residue from the distillation is transferred to a sublimation apparatus and sublimed at 40-60° C. at 1×10⁻³ mbar. This gives 40 mg (5%) of pure 2 in the form of a colourless oxidation-sensitive solid.

Characterization of 1:

²⁹Si NMR (C₆D₆): δ=−92.71 ppm (q, ¹J_{Si—H}=201 Hz, SiH₃); −150.42 ppm (m, ²J_{Si—SiH}=3 Hz, Si_{q})

¹H NMR (C₆D₆): δ=3.48 ppm (s, 18H, SiH₃)

MS: 242 (M+), 210 (M+-SiH₄), 178 (M+-2 SiH₄), 146 (M+-3 SiH₄)

Characterization of 2:

²⁹Si NMR (C₆D₆): δ=−146.50 ppm (m, ²J_{Si—H}=2.7 Hz, Si(SiH₃)₃), −135.26 ppm (m, ²J_{Si—H}=3.0 Hz, Si(SiH₃)₂), −93.65 ppm (q, ¹J_{Si—H}=201.4 Hz, ³J_{Si—H}=3.2 Hz, Si(SiH₃)₃); −90.11 ppm (q, ¹J_{Si—H}=201.6 Hz, ³J_{Si—H}=3.6 Hz, Si(SiH₃)₂)

¹H NMR (C₆D₆): δ=3.54-3.56 (m, SiH₃)

MS: 332 (M⁺), 300 (M⁺-SiH₄), 268 (M⁺-2 SiH₄)

### EXAMPLE 3

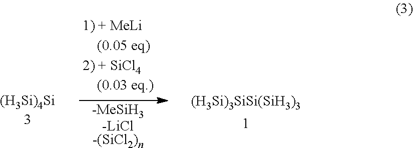

To 1.00 g NPS (6.6 mmol, 1 equivalent) is added, at −30° C. 0.20 ml of a 1.6 M solution of MeLi in diethyl ether (0.3 mmol, 0.05 equivalent), and then the mixture was stirred at −30° C. for 10 min. Subsequently, 0.03 g of tetrachlorosilane (0.1 mmol, 0.03 equivalent) is added dropwise to the reaction solution and the mixture is stirred at room temperature for 45 minutes. Then the solvent is removed under reduced pressure at 0° C., and the remaining oily product mixture is recondensed at 38-40° C. at 0.05 mbar=5 Pa. This gives 0.16 g (20%) of pure 1 in the form of a clear oxidation-sensitive liquid.

TABLE 1
Quantitative evaluation of the product mixture obtained according to
Example 1 (route A, dibromoethane as electrophile)^{§}.
Amount used: 1 g of NPS 3

| | | | Octasilane |
|---|---|---|---|
| | Solid residue | Soluble fraction | (isolated) |
| Theoretical | 0.5 g LiBr | 0.8 g higher silanes | 0.8 g |
| amount | | | |
| Experimental | 0.4 g | 0.4 g | 0.2 g |
| amount | | | (after |
| | | | condensation) |
| Analysis | LiBr + nonvolatile | 1, 2 further | 1 |
| | polymeric | oligomeric H- | |
| | hydridosilanes* | silanes^{#} | |
| Yield | | 50% | 25% |

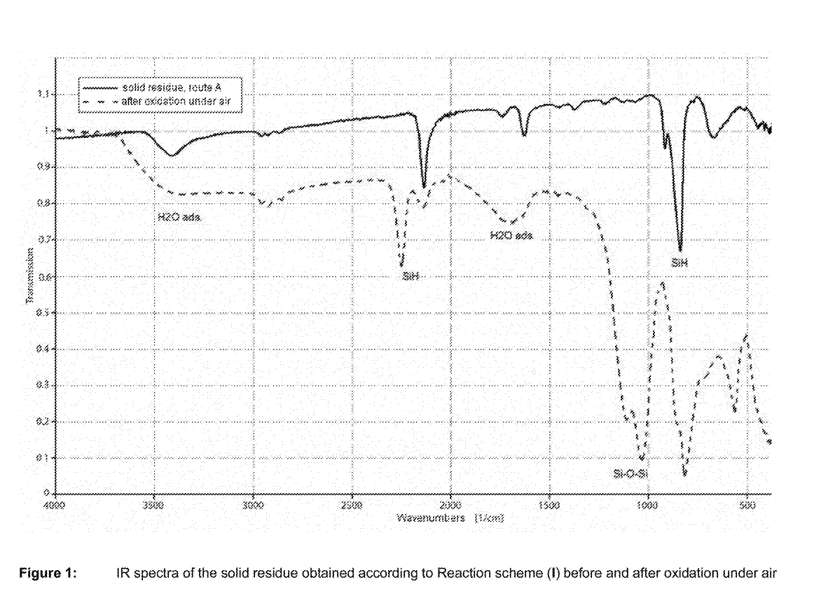

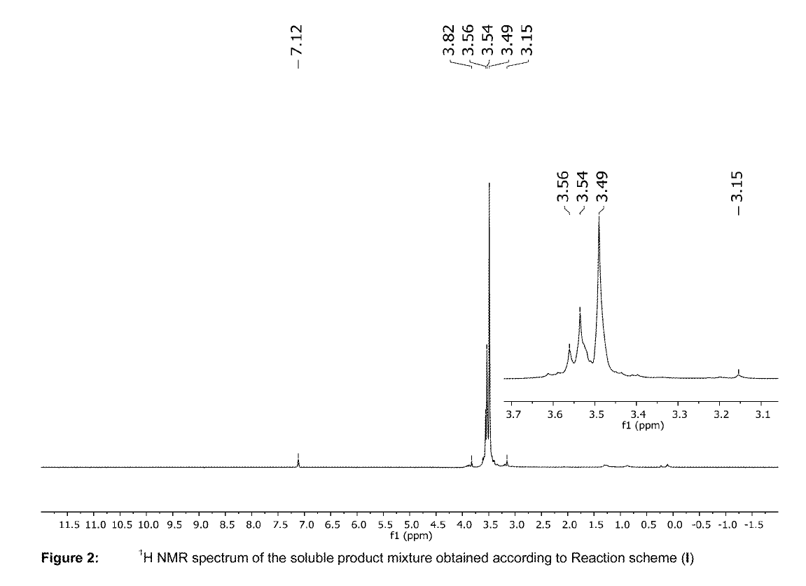

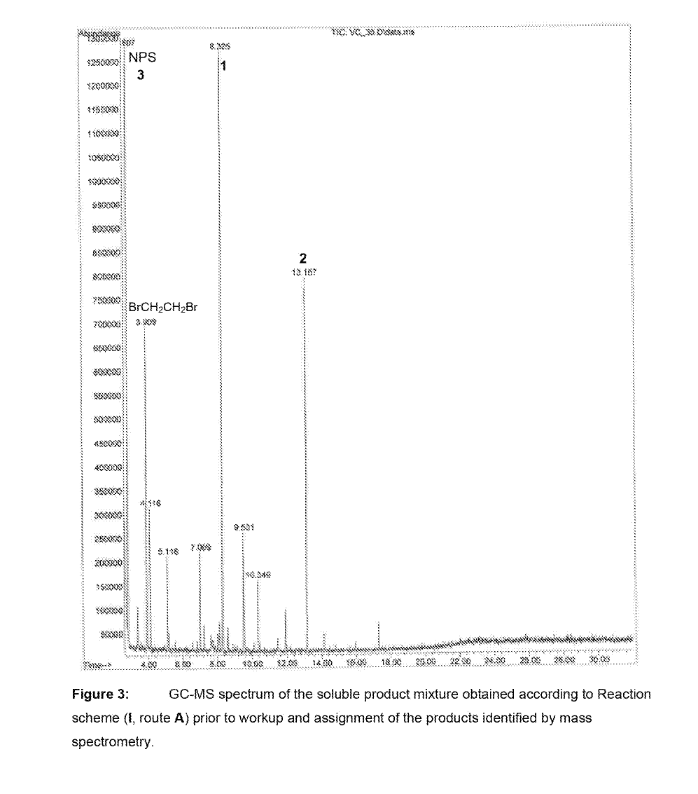

^{§}GC-MS analysis reveals equal amounts of 1 and 3 (see FIG. 3).
*determined by IR spectroscopy (FIG. 1)
^{#}determined by NMR spectroscopy (FIG. 2)

TABLE 2
Quantitative evaluation of the product mixture obtained according to
Example 2 (route B, tetrachlorosilane as electrophile)^{§}.
Amount used: 1 g of NPS 3

| | | | Octasilane |
|---|---|---|---|
| | Solid residue | Soluble fraction | (isolated) |
| Theoretical | 0.25 g LiCl | 0.8 g higher silanes | 0.8 g |
| amount | | | |
| Experimental | 0.35 g | 0.55 g | 0.2 g |
| amount | (solid residue) | (soluble fraction) | (after |
| | | | condensation) |
| Analysis | LiCl + nonvolatile | 1, 2 further | 1 |
| | polymeric | oligomeric H- | |
| | hydridosilanes* | silanes^{#} | |
| Yield | | 70% | 25% |

^{§}detection by means of GC-MS
*determined by IR spectroscopy (FIG. 1)
^{#}determined by NMR spectroscopy (FIG. 2)

FIG. 2 shows the ¹H NMR spectrum of the extracted product mixture as results from the process according to the invention. The registered resonance signals in the region of 3-4 ppm are typical of SiH₃ groups and reveal at least 3 species of hydridosilanes of the formula SiₘH₂ₘ₊₂ with m>5.

A broad signal in this region which is typical of polymeric hydridosilanes is not registered.

The main constituents of the crude product mixture prior to distillative workup are 1 (at least 30%), 2 (at most 10%) and 3 (at most 30%), determined as area % in a gas chromatography measurement.

The finding is supported by the results from coupled gas chromatography and mass spectrometry studies; see FIG. 3.

Removal of the solid and volatile constituents (essentially 3) leaves, in the liquid phase under SATP, 50-70 area % of soluble higher silanes, the difference from 100 area % comprising nonvolatile higher hydridosilanes of the formula SiₙH₂ₙ₊ₘ with m=0, 2, especially m=2 and n>11.

1 can be isolated in pure form in about 25% yield.

The solid residue contains, as well as the LiX (X=Br, Cl) formed, also relatively small amounts of insoluble polymeric hydridosilanes. This becomes clear from the IR spectroscopy data disclosed in FIG. 1. The registered bands in the region of about 2100 cm⁻¹ and of about 800 cm⁻¹ are typical of compounds having Si—H bonds. On contact with moisture, additional bands appear in the IR spectrum in the region of 3400 cm⁻¹ and 1600 cm⁻¹, which are attributable to adsorbed water and increase in intensity on prolonged contact with moisture; see lower IR spectrum in FIG. 1.

Further bands appear in the region of 1200 cm⁻¹ on prolonged contact with moisture, which are typical of siloxanes. They indicate the oxidation of the nonvolatile polymeric hydridosilanes to corresponding polymeric siloxanes as breakdown product.

Irrespective of the electrophile chosen in the process according to the invention, with regard to the solid residue obtained, identical results are obtained in the IR spectroscopy data. This residue is thus a mixture of LiX with X=Br or Cl and polymeric hydridosilanes, which, as well as a low vapour pressure, additionally feature sparing solubility in nonpolar solvents or nonpolar solvent mixtures.

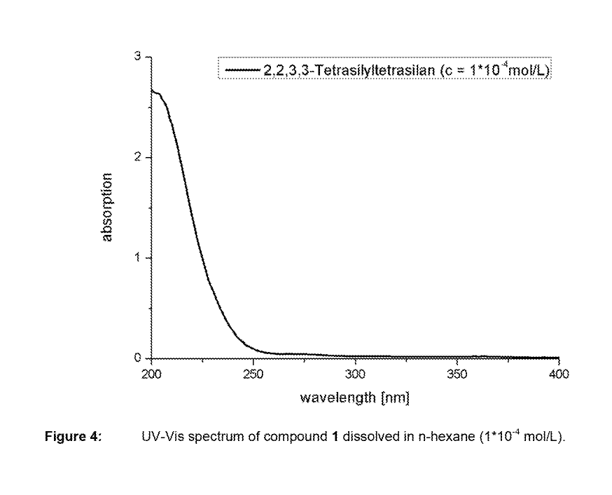

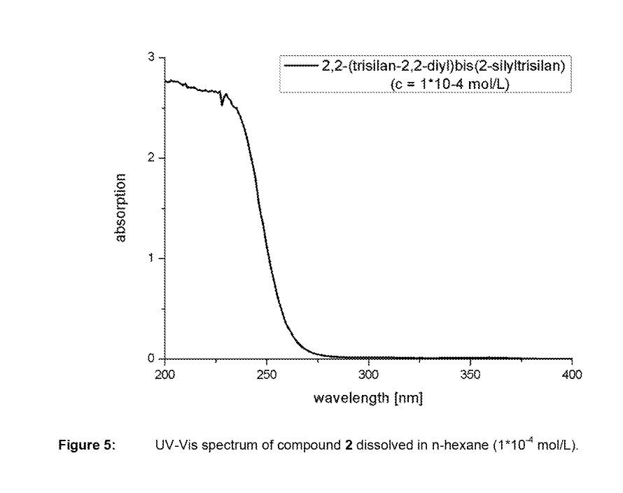

The registered UV-Vis spectra of compound 1 and compound 2 are disclosed in FIG. 4 and FIG. 5 at concentrations of 1*10⁻⁴ mol/L.

1. 2,2,3,3-Tetrasilyltetrasilane of the formula 1, having:
a molecular mass, determined by mass spectrometry, of 242 g/mol;
a ²⁹Si NMR spectrum with 2 resonance signals, the first signal having a chemical shift of δ=−92.71 ppm and the form of a quartet with a heteronuclear coupling ¹J_{Si—H}=201 Hz (SiH₃), and the second signal a chemical shift of δ=−150.42 ppm and the form of a multiplet with a heteronuclear coupling ²J_{Si—H}=3 Hz, (Si_{q});
a ¹H NMR spectrum with signals typical of SiH₃— groups and a chemical shift in the region of 3-4 ppm, where an integration across these signals corresponds to a sum total of 18 protons and the chemical shifts of the ²⁹Si and ¹H NMR spectra are based on tetramethylsilane as a reference standard

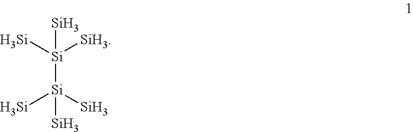

2. 2,2,3,3,4,4-Hexasilylpentasilane of the formula 2, having:
a molecular mass, determined by mass spectrometry, of 332 g/mol;
a ²⁹Si NMR spectrum with 4 resonance signals, the first signal having a chemical shift of δ=−146.50 ppm and the form of a multiplet with a heteronuclear coupling of ²J_{Si—H}=2.7 Hz (Si(SiH₃)₃), the second signal a chemical shift of δ=−135.26 ppm and the form of a multiplet with a heteronuclear coupling of ²J_{Si—H}=3.0 Hz (Si(SiH₃)₂), the third signal a chemical shift of δ=−93.65 ppm and the form of a quartet with heteronuclear coupling constants of ¹J_{Si—H}=201.4 Hz and ³J_{Si—H}=3.2 Hz (Si(SiH₃)₂), and the fourth signal a chemical shift of δ=−90.11 ppm and the form of a quartet with heteronuclear coupling constants of ¹J_{Si—H}=201.6 Hz, and ³J_{Si—H}=3.6 Hz (Si(SiH₃)₃);
a ¹H NMR spectrum with signals typical of SiH₃— groups and a chemical shift in the region of 3-4 ppm, where the chemical shift of the ¹H NMR spectrum is based on tetramethylsilane as reference standard

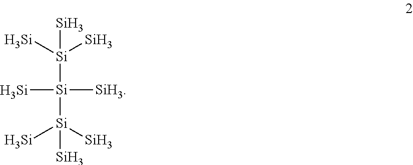

3. A composition comprising the 2,2,3,3-tetrasilyltetrasilane of the formula 1 according to claim 1, and one or more additional constituents that are not 2,2,3,3-tetrasilyltetrasilane of the formula 1.

4. The composition according to claim 3, comprising at least 30 area % of the 2,2,3,3-tetrasilyltetrasilane, not more than 10 area % of 2,2,3,3,4,4-hexasilylpentasilane and not more than 30 area % of neopentasilane, where the difference from 100 area % includes higher hydridosilanes of the formula SiₙH₂ₙ₊ₘ with m=0, 2 and n≥5, unconverted reactants and by-products that are not hydridosilanes, and where the stated area percentages are based on the total area of a gas chromatography measurement.

5. The composition according to claim 4, in the liquid phase under standard conditions/SATP, freed of unconverted reactants and by-products, comprising 50-70 area % of the 2,2,3,3-tetrasilyltetrasilane, 2,2,3,3,4,4-hexasilylpentasilane, and higher hydridosilanes of the formula SiₙH₍₂ₙ₊ₘ₎ with m=0, 2 and n>5, where the difference from 100 area % comprises nonvolatile higher hydridosilanes of the formula SiₙH₍₂ₙ₊ₘ₎ with m=0, 2 and n>11, and where the stated area percentages are based on the total area of a gas chromatography measurement.

6. The composition according to claim 3, wherein the one or more additional constituents that are not 2,2,3,3-tetrasilyltetrasilane of the formula 1 comprise 2,2,3,3,4,4-hexasilylpentasilane.

7. The composition according to claim 6, wherein the one or more additional constituents that are not 2,2,3,3-tetrasilyltetrasilane of the formula 1 further comprise neopentasilane.

8. The composition according to claim 3, wherein the one or more additional constituents that are not 2,2,3,3-tetrasilyltetrasilane of the formula 1 comprise:
2,2,3,3,4,4-hexasilylpentasilane,
neopentasilane, and
a compound of formula SiₙH₂ₙ₊ₘ with m=0 or 2 and n>11.

9. A process for preparing a higher hydridosilane of the formula SiₙH₂ₙ₊ₘ with m=0 or 2 and n≥5, comprising:
a) providing one or more metal silanides of the formula M(SiₙH₂ₙ₊ₘ)ₒ with 1≤n≤12, m=1, −1, o=1, 2 and M=alkali metal, alkaline earth metal;
b) reacting the metal silanides of the formula M(SiₙH₂ₙ₊ₘ)ₒ with 1≤n≤12, m=1, −1, o=1, 2 and M=alkali metal, alkaline earth metal, with one or more electrophiles selected from the group consisting of the element halides and the element organyl halides, where the subgroup of the element organyl halides comprises element alkyl or aryl halides, each of the 4th main group of the Periodic Table of the Elements; and
c) working up the reaction mixture obtained from b) to obtain a mixture of hydridosilanes of the formula SiₘH₂ₘ₊₂ with m≥5.

10. The 2,2,3,3-Tetrasilyltetrasilane according to claim 1, obtained by a process comprising:
a) providing a metal silanide of the formula M(SiₙH₂ₙ₊ₘ)ₒ with 1≤n≤12, m=1, −1, o=1, 2 and M=alkali metal, alkaline earth metal;
b) reacting the metal silanide with an electrophile selected from the group consisting of the element halides and the element organyl halides, where the subgroup of the element organyl halides comprises element alkyl or aryl halides, each of the 4th main group of the Periodic Table of the Elements; and
c) working up the reaction mixture obtained from b) to obtain the 2,2,3,3-tetrasilyltetrasilane.

11. A mixture of higher hydridosilanes of the formula SiₙH₂ₙ₊ₘ with m=0, 2 and n≥5, obtained by a process comprising:
a) providing a metal silanide of the formula M(SiₙH₂ₙ₊ₘ)ₒ with 1≤n≤12, m=1, −1, o=1, 2 and M=alkali metal, alkaline earth metal;
b) reacting the metal silanide with an electrophile selected from the group consisting of the element halides and the element organyl halides, where the subgroup of the element organyl halides comprises element alkyl or aryl halides, each of the 4th main group of the Periodic Table of the Elements; and
c) working up the reaction mixture obtained from b) to obtain a mixture of silanes of the formula SiₙH₂ₙ₊ₘ with m=0, 2 and n≥5.

12. (canceled)
